(19) United States
(12) Patent Application Publication
(10) Pub. No.: US 2013/0143519 A1
(43) Pub. Date: Jun. 6, 2013

(54) Fall-Responsive Emergency Device, System, and Method

(71) Applicant: J&M I.P. HOLDING COMPANY, LLC, Traverse City, MI (US)

(72) Inventor: Mary Doezema, Traverse City, MI (US)

(73) Assignee: J&M I.P. HOLDING COMPANY, LLC, Traverse City, MI (US)

(21) Appl. No.: 13/751,714

(22) Filed: Jan. 28, 2013

Related U.S. Application Data
(63) Continuation-in-part of application No. 13/812,010, filed on Jan. 24, 2013.

(51) Int. Cl. G08B 21/04

(52) U.S. Cl. CPC G08B 21/0446
USPC 455/404.2

(57) ABSTRACT

A system comprising a wearable device with a fall sensor responsive to the physical effect of a fall by a user wearing the device to generate a sensed-fall signal; a plurality of local communicators capable of receiving the sensed-fall signal and transmitting a fall alert; a base transmitter comprising a communications portal capable of initiating communication with a remote responder and establishing two-way voice communication between the remote responder and the user of the wearable device via the local communicators; the local communicators capable of establishing a perimeter and sending an alert if the wearable device is not within the perimeter boundary; a charging plate for induction charging the wearable device; and a mobile application adapted for use on a remote responder's mobile device, the mobile application capable of being activated by communication from the base transmitter to alert the remote responder of the fall or emergency event.

### CLAIM OF PRIORITY

This application is a continuation-in-part application that claims priority to and the benefit of the filing date of U.S. patent application Ser. No. 13/812,010 filed on Jan. 24, 2013, which in turn claims priority to and the benefit of the filing date of PCT Application PCT/US 10/43678, filed on Jul. 29, 2010, both of which are incorporated herein in their entireties by reference.

### TECHNICAL FIELD

The subject matter of the present application is in the field of wireless wearable emergency devices, the devices having capability to alert others at distant locations of the existence of an emergency or a need for assistance experienced by the person wearing the device. These may sometimes also be referred to as “aging-in-place” or “caregiver assistance” devices.

### BACKGROUND ART

Wearable devices capable of transmitting “personal assistance needed” or emergency signals to remote friends, relatives, caregivers, and emergency personnel (hereafter “remote responders”) are generally known. These devices typically require conscious activation of an emergency alert transmitter to notify remote responders of the existence of a medical, personal or other emergency. For example, some devices effectively function as wearable, easy-to-use emergency phones; other devices send a simple alert signal in response to the press of a button or some other deliberate signal activation by the person wearing the device. Persons with potential need for such devices include older adults, individuals living alone, persons with disabilities or chronic diseases, infants in danger of being shaken, and individuals working in high places such as rooftops, ladders or scaffolds.

Prior devices require the person wearing the device to be conscious and able to make a call or activate a signal, to be free of Alzheimer's, Parkinson's or other related diseases affecting the nervous system so they can reach the device, and to generally be in awareness of the emergency situation. Prior devices may also rely on voice communication to indicate the nature of the emergency, which can be limiting in some circumstances. Prior devices may also rely on remote call centers to receive and process calls.

As described in the application to which this continuation-in-part application claims priority, U.S. Ser. No. 13/812,010, filed on Jan. 24, 2013, a wearable, hands-free emergency alert device and system are provided that responds automatically to a measurable physical effect of a slip, trip, fall or similar accident or potentially injurious event (hereafter “fall”) by the wearer to send an alert signal to a remote responder. Measurable physical effects include, but are not limited to, movement, vibration, and/or sound.

The wearable device incorporates a fall-sensor capable of recognizing the physical effect of a fall or similar abnormal motion (as distinguished from non-emergency movements and vibrations) and a wireless transmitter that sends a wireless alert signal in response to a sensed fall. The wearable fall-responsive device may optionally include a manual alert to signal non-fall emergencies.

The system includes the wearable fall-responsive device and an on-premises transmitter (“base transmitter”) for responding to the alert signal by sending a request for a remote responder (someone located off-premises). In a further form the system includes one or more local wireless two-way voice communicators that are located on-premises in signal communication with the base transmitter and in stationary locations within voice distance of possible fall locations that are separate from the wearable device and that can be enabled for two-way voice communication between a remote responder and a fallen person after the responder receives the request from the base transmitter. In a further form, the on-premises two-way voice communicator receives the alert signal from the wearable fall-responsive device and enables the base station transmitter to request a remote responder.

In a further aspect, some or all of the two-way voice communication enabled between the local communicator and the fallen person is independent of the wearable device; i.e., although the wearable device might include a voice transmitter and/or receiver to boost the ability of a fallen person to communicate by voice with the local communicator, the local communicator is able to provide direct voice-to-voice communication with the fallen person.

The application further comprises a method for responding to a monitored person's fall or emergency in which a fall-sensing device is worn, a fall alert signal is delivered wirelessly to enable a base transmitter, the base transmitter is activated to send a responder request to a remote responder, and, if available, the remote responder enables two-way voice communication with the fallen wearer via an on-premises two-way communication device separate from the wearable device. In a further form, the alert signal is received by the on-premises two-way communication device, which then enables the base station transmitter.

In one form, the wearable device senses a fall or emergency with a vibration sensor. In another form, the wearable device senses a fall with an accelerometer.

In a further form, the on-premises two-way communication device is a fixture on the premises.

### BRIEF SUMMARY

The fall alert system may establish one or more perimeters and be capable of sending a boundary alert signal if the wearable device moves out of contact with the location communicators. In another aspect, the system may be capable of tracking movement of the wearable device and displaying location history information on a web portal.

The system may comprise a charging plate capable of charging the wearable device with induction charging. Other system examples may include a charger capable of wireless charging of the wearable device. In a further aspect, the system may include a mobile application adapted for use on a mobile device of a remote responder which may be activated upon receipt of a communication from the base transmitter. In a further aspect, the system may include a web-based portal adapted for use upon a computing platform for displaying information about the user of the wearable device, caregiver information, location information of movements of the wearable device, and other information. A caregiver may be able to enter data onto the web-based portal. The system may include a remote database server capable of receiving data from the base transmitter and/or wearable device, as well as data entered in web-based portal, and synching the data. The web-based portal may be capable of displaying data from the remote database server.

These and other features will become apparent from the detailed description below in light of the accompanying drawings.

### BRIEF DESCRIPTION OF THE DRAWINGS

FIG. 1 is a perspective view of an example fall response system.

FIG. 2 is a schematic view of an example fall response system on a premises where a person wearing the wearable device might fall.

FIG. 3 is a schematic representation of a fall or emergency event in the system-equipped premises of FIG. 2 and of a chain of signaling and communication between a fallen person and a remote responder.

FIG. 4 is a functional flowchart representation of a method using the system of FIG. 2.

FIG. 5 is a perspective view of a wearable device capable of sending a fall-responsive alert signal.

FIG. 5A is an exploded assembly view of the device of FIG. 1. FIGS. 6A-6F are perspective views that show various base transmitter examples.

FIG. 6G is a block diagram showing example electrical components of the base transmitter.

FIGS. 7 and 7A-7K are perspective views that show various local communicator examples.

FIG. 7L is an example block diagram of a local communicator.

FIG. 8 is a perspective view of a charger unit example.

FIG. 8A is an exploded assembly view of a bracelet and charging plate example.

### DETAILED DESCRIPTION

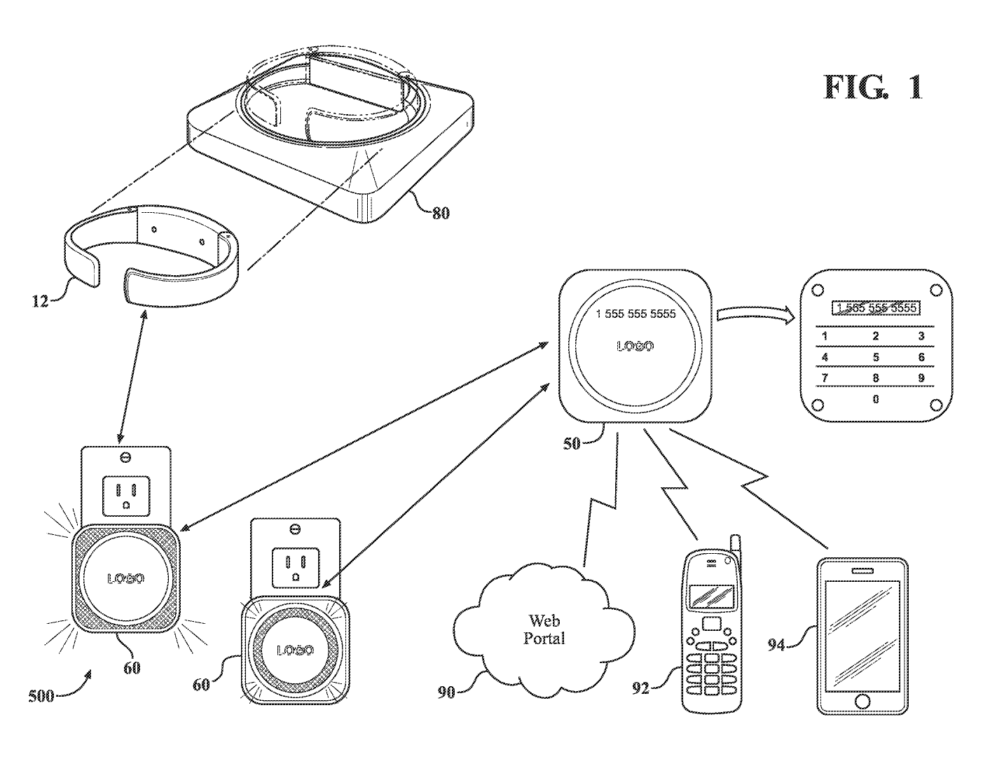

Referring to FIG. 1, an example fall or emergency response system 200 is shown. System 200 may be used to alert a remote responder to a fall event of a user or other emergency event. For example, a user could fall, stumble or misstep due to internal health or body related circumstances. A user could fall, stumble, or misstep due to external force being applied to the user, such as from an attack by another, an object falling on a user, or other external forces. A user could fall due to environmental factors and/or situation factors pertaining to the user's physical, mental and/or health condition(s). For example, an elderly user could stumble due to a heart attack; a child could fall from being pushed by a bully; a man carrying a laundry basket could fall down a staircase; a young woman could slip on a wet floor. Numerous other examples are possible, and these particular examples are not intended to be limiting.

System 200 may respond to other triggering events, such as a user moving outside of a boundary or perimeter. For example, a user could leave a premises, enter a swimming pool area, go into a basement, enter an automobile or enter or leave another perimeter or boundary area triggering an alert. System 200 may be used inside a premises, such as a dwelling, building, campus, hotel room, healthcare facility, complex or the like, and/or be portable and used in various combinations of different areas. System 200 may be used in outside areas, such as yards, neighborhoods, townships, cities, counties, and the like. It may be used to establish grids of varying sizes, depending upon its installation and settings. Many other areas are possible.

System 200 includes wearable device 12, which may be a bracelet or any other wearable device. Bracelet 12 contains a battery to provide power to it and may be charged upon a charger, such as charging plate 80. Other system 500 examples may utilize different types of chargers, including without limitation, wireless charging, contact charging, induction charging, plug-in adapter charging and various charging methods known in the art.

Bracelet 12 is capable of sensing a triggering event, such as a fall event—meaning that a user wearing bracelet 12 has fallen, or another emergency event. Other triggering events may include, without limitation, notice that bracelet 12 has crossed a perimeter or boundary of system 500, notice that bracelet 12 has been inactive for a time period, and the like. Various other triggering events are possible. Bracelet 12 will be discussed in more detail below.

System 500 includes one or more or a plurality of local communicators 60 which are capable of two-way communication with bracelet 12. Local communicators 60 may be wall units in one example, such as a wall unit adapted to be plugged into an electrical outlet. Other examples are possible. Local communicators 60 will be discussed in more detail below. Local communicators 60 are capable of receiving one or more signals from bracelet 12 indicating that a fall or emergency event has occurred. Upon receipt of a fall or emergency event signal, a local communicator 60 may communicate with base transmitter 50 to provide base transmitter 50 notice of the fall or emergency event. For example, the local communicator 60 may generate a fall alert and transmit the fall alert to base transmitter 50. The fall alert may include data about the fall or emergency event, such as which local communicator 60 received the information (for a system 500 with more than one local communicator 60), time of the event, location of bracelet 12, and/or other information.

Upon receipt of the fall or emergency event notification, base transmitter 50 is capable of initiating communication to a remote responder to notify the responder of the fall or emergency event. For example, base transmitter 50 may have a communications portal capable of telephonic, Ethernet, wireless, Wi-Fi, cellular, satellite or other communications. As shown with reference to this drawing, base transmitter 50 may initiate a telephone call to remote telephonic device 92. A remote telephonic device may include a landline telephone, a cellular telephone, a mobile device, smartphone, tablet, PC, computing platform or any other device known in the art that is capable of receiving a telephonic communication. Base transmitter 50 may communicate with a telephonic device, computing platform or other device capable of receiving SMS, text messaging, email or other written communications by sending a written communication contained fall or emergency event information. Base transmitter 50 may communicate with a web portal 90 to provide fall or emergency event information and/or other system or wearable device information. Base transmitter 50 may communicate with and/or trigger activation of a mobile application 94 adapted for use on a mobile device, such as that of a remote responder, to notify a remote responder of the fall or emergency event.

Base transmitter 50 may also open up two-way voice communication between a remote responder and one or more local communicators 60 so that a remote responder may speak with the user of bracelet 12 via speaker functionality of local communicators 60. Base transmitter 50 may include a programmable key pad adapted for programming one or more contact numbers for one or more remote responders for use upon receipt of a fall or emergency event.

System 500 may include a charger, such as charging plate 80 capable of charging bracelet 12 by induction. Other examples may include a charger capable of wireless charging of bracelet 12. System 500 may include further functionality and/or components as discussed below.

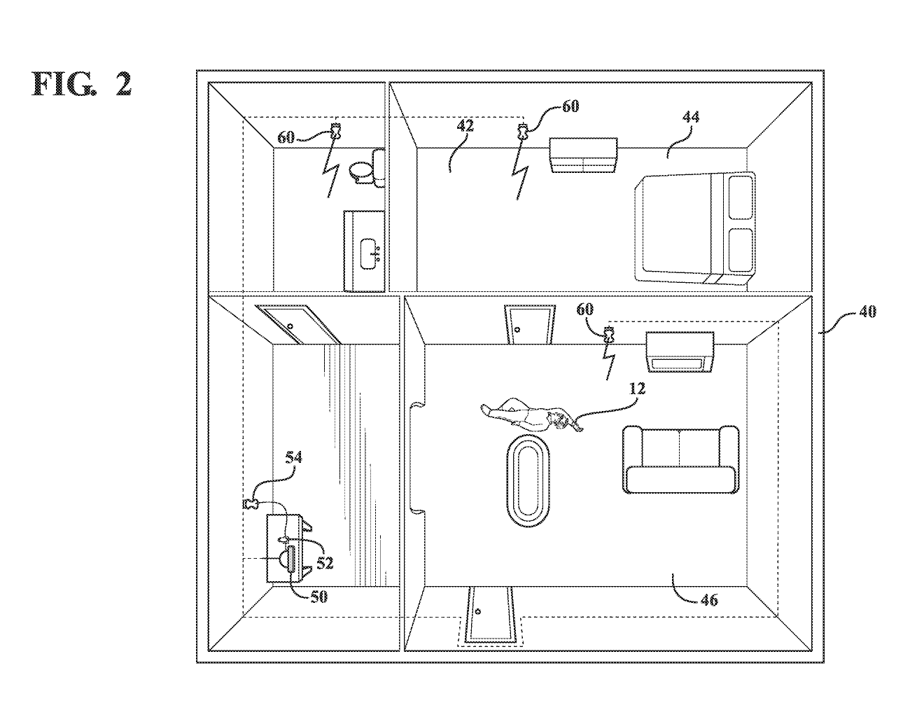

Referring next to FIG. 2, a premises 40, such as a house, is equipped with a system 500 that incorporates bracelet 12 and that responds to the wireless alert signal produced by bracelet 12 during a fall or emergency event. Premises 40 has one or more possible fall locations, for example a bathroom 42, a bedroom 44, and a living room 46. Other locations could include, in various examples, a basement, outbuilding, front or back porch, yard, attic, garage, driveway, patio and/or other indoor and/or outdoor areas. A base transmitter 50 is located on-premises and contains or is connected to communication gateway 52 for communicating with one or more remote responders who may be off-premises. While FIG. 2 depicts a communication gateway 52 external to base transmitter 50, other examples include this functionality internally within base transmitter 50.

For example, base transmitter 50 may include Ethernet and/or telephone ports and communicate with one or more responders via direct or indirect connection to a telephone, Internet access or other data transmission line. In other examples, base transmitter 50 may use wireless technology known in the art to connect to a router, modem or other device to obtain telephonic, Internet or other data transmission access. Base transmitter 50 may communicate with remote responders by Bluetooth, cellular, WIFI or other wireless communications technology known in the art. Base transmitter 50 may act as an Ethernet enabled wireless gateway or router to provide interaction with other system components 90, 92 and/or 94 (shown in FIG. 1) to communicate with remote responders. For example, base transmitter 50 may contain Wireless M-bus functionality or other wireless or WIFI capabilities know in the art. Other protocols are possible. In this manner, base transmitter 50 may interface the system 500 to the outside world.

In the illustrated example, base transmitter 50 is a device that receives an RF signal from an associated device, in this case local communicator 60. However, other types of wireless signals are possible for communications between base transmitter 50 and local communicators 60. For example, base transmitter 50 and local communicators 60 may communicate via Bluetooth wireless signals or other protocols known in the art.

Once activated, the internal programming of base transmitter 50 may call one or more (e.g., five) pre-determined and programmed telephone numbers, or send programmed text messages, or otherwise make a contact attempt with a remote responder using any known and conveniently used form of communication, such as, but not limited to, web portal 90, telephone 92 and/or mobile application 94. Base transmitter 50 may use a call service and/or Internet based calling technologies and functionality, such as a PBX service, for detecting a communications connection with a remote responder and/or an IVR or other system to detect whether a person or machine, such as computerized voicemail, have answered the line so as to attempt to reach a live person if the communication is telephonic. Ethernet based calls may use VOIP or other voice transmission protocols. In various examples, base transmitter 50 may initiate contact with the pre-programmed contacts in a set order, all at once, and/or in batches.

In one example, once the communication and/or signal is received by a remote responder, he or she may hear a customizable pre-recorded alert message from system 500, indicating that a fall or emergency event has occurred, and the base transmitter 50 may open two-way communication between the remote responder (via the communications link) and the local communicator 60 (via its transceiver and speaker functionality). If the remote responder does not answer or receive the communication, base transmitter 50 may initiate communication to a second remote responder contact (which may be a second contact number for a particular remote responder and/or contact information for a different remote responder), and so on, and so on, if more than one remote responder contact information is programmed into system 500. If no remote responder in the pre-programmed list answers/receives the communication, base transmitter 50 may be programmed to contact emergency personnel and/or a call center.

In another example, once the communication and/or signal is received by a remote responder, he or she may manually enter a form of pre-programmed coded message; for example, either a number or letter combination (similar to remotely checking your voice mail). Once the proper code is entered, the base transmitter 50 opens communication between the fallen person via the local communicator 60 and the responder. In this example, two-way voice communication between the remote responder and the local communicator is not automatically initiated. If no code is entered, base transmitter 50 can be programmed to call a call center or emergency services.

In a further example, once a communication link is established, base transmitter 50 may open up two-way communications between the remote responder and only the local communicator 60 nearest the user of bracelet 12. Base transmitter 50 may employ Bluetooth or other wireless protocol to connect the remote responder to the local communicator 60 that sent the fall alert signal via radio or other wireless protocol to base transmitter 50 to indicate a fall or emergency event.

Other examples of system 500 may include more than one bracelet 12. Each bracelet 12 may have its own unique identifier so that system 500 may identify the locations and fall or emergency events or other triggering events associated with a particular bracelet 12. For systems 500 with multiple bracelets 12, base transmitter 50 may include communication portals separately for each bracelet 12 so as to be capable of multiple communications at once for different bracelets 12 substantially simultaneously. Other examples may have a single communications portal for events of all bracelets 12.

Other triggering events may include bracelet 12 moving out of range of system 500, in which case, an alert may be sent from system 500 to a remote responder. In this manner, the local communicators 60 of system 500 may establish one or more boundaries or perimeters. In order to determine whether bracelet 12 is within range and with power, local communicators 60 may send a signal to “ping” bracelet 12 at various preset intervals. If the “ping” signal detects bracelet 12, the location of bracelet 12 within the system 500 may be recorded. If the “ping” does not detect bracelet 12, the system 500 may send an alert to a remote responder. Other examples may include bracelet 12 sending a response signal to local communicators 60 in response to receipt of the “ping” signal. Failure by local communicators 60 to receive the response signal may trigger an alert. Failure by local communicators 60 to receive a response signal from bracelet 12 may indicate that bracelet 12 has moved out of range of the local communicators 60 of system 500. It may also indicate that bracelet 12 has lost power in some examples.

A further triggering event may be that bracelet 12 remains in one location for a pre-determined period of time. This may cause an alert to be sent by system 500 to a remote responder. This functionality may help a remote responder discover if a user has taken bracelet 12 off and/or is immobile, unconscious or needs assistance.

A further triggering event may be that bracelet 12 is low on and/or loses power, which may indicate that it needs to be charged. If bracelet 12 is low on power and/or loses power, system 500 may send an alert to a remote responder.

In the illustrated example of FIG. 2, communication gateway 52 is a telephone communicating with the outside world by landline 54, but as discussed above and shown in FIG. 1, wireless and other communications are possible, and claimed subject is not limited to landline embodiments of the system. In addition to those discussed above with reference to FIG. 1, other possibilities for the remote communication gateway 52 may also include (but are not limited to) cable modems, satellite dishes, mobile phones, or long-range RF transmitters. The connection between base transmitter 50 and the remote communication gateway 52 may be wireless or wired.

If a person wearing bracelet 12 should fall on premises 40 (or another triggering event occurs), bracelet 12 sends a wireless alert signal that is received by the base transmitter 50 or that is relayed in original or modified signal form by an intermediate device to base transmitter 50. Base transmitter 50 is then enabled to request the intervention or assistance of a remote responder by sending a predetermined remote responder request via phone 52. Again, phone 52 shown in FIG. 2 is merely one example of a possible communicator and others are possible, as shown in FIG. 1. The remote responder request can be any signal or message capable of being transmitted off-premises and being recognized by a remote responder (human or automated); for example, a pre-recorded voice message, an email or text, a distinctive tone, or a machine-readable alarm signal. In situations and on premises where a remote responder may be within hearing of the premises 40, one possible remote responder request could be a tactile alarm that is audible or visible from off-premises.

It will also be understood that “on-premises” and “off-premises” could be locations included in a single dwelling or building not normally in communication with each other; for example, two different apartments in an apartment building or two different floors in a skilled nursing or rehabilitation facility, dementia care or assisted living facility or senior residential community or continuum of care facility, a hospital or a medical clinic, such as, but not limited to, where a remote responder is located far enough from the person wearing bracelet 12 that he or she would not be likely to hear a fall or emergency event, and would need to be notified via base station 50 of the event. Of course, system 500 may be used if a remote responder is in the same premises, proximity and/or room in a dwelling, vehicle or other place with the user of bracelet 12.

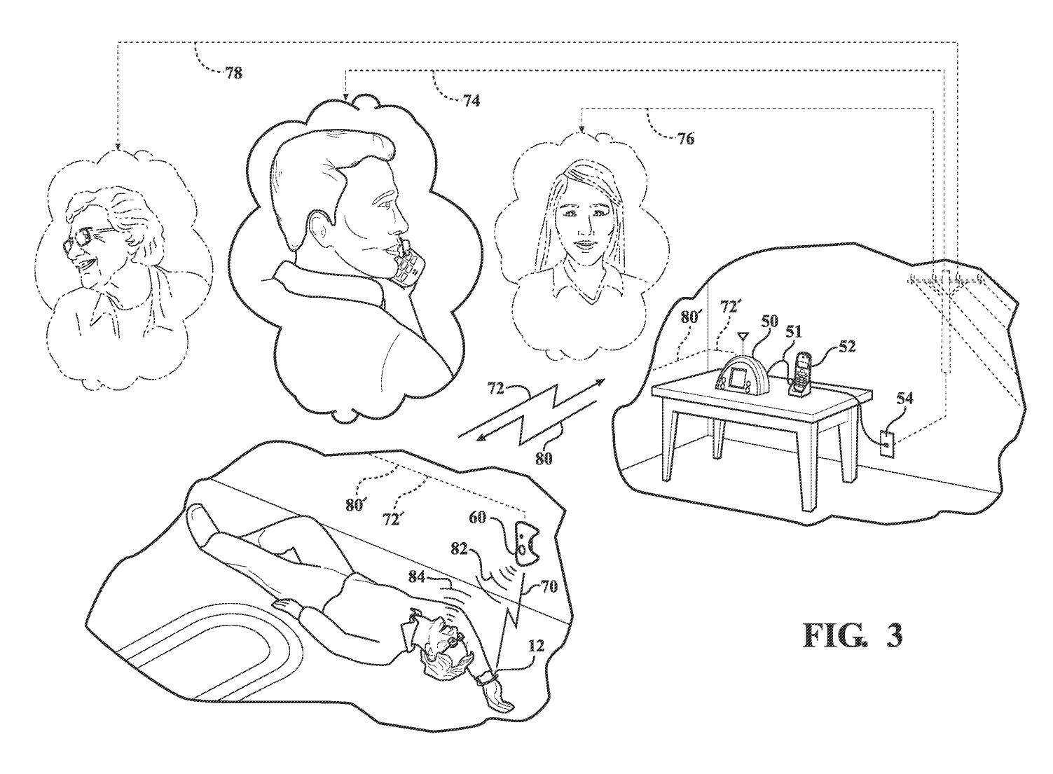

Referring next to FIG. 3, the system also includes one or more local communicators 60 mounted in various stationary locations on the premises 40 within voice communication distance of possible fall locations. Communicators 60 are stationary in use, although they need not be permanently fixed in place and could be moved to different locations for optimum voice communication based on testing and/or as needed on the premises given anticipated fall locations. Examples of stationary locations include, but are not limited to direct plug-in connection in electrical outlets, wall-mounted locations, furniture-mounted locations, and attachment to or incorporation into appliances.

In the illustrated example of FIG. 3, a person wearing bracelet 12 has fallen in a room of the house 40 different than the room in which base station transmitter 50 is located. Bracelet 12 senses the fall and sends a wireless alert signal 70 to two-way local voice communicator unit 60 mounted in a wall outlet in the room where the fall occurred. Local communicator 60 in turn either relays the fall alert signal or sends a fall notification signal (hereafter both referred to as “notification” signal) to base station 50 via wireless signal 72 and/or wire-transmitted signal 72′. Base station 50 is enabled to generate a responder request signal which is transmitted through connection 51 (wired or wireless) to remote communication means 52 (a telephone or modem) which sends the request off-premises via communication link 54 (landline). The remote responder request is sent to at least one predetermined responder R1 and preferably to additional responders R2, R3, . . . , over respective communication links 74, 76, and 78. For example, the phone/modem 52 dials five pre-programmed telephone numbers in preset order. The remote responders' telephone or other contact connections (email, fax, mobile phone, text) are programmed into the base station transmitter 50 or the remote communication means 52.

In the illustrated example of FIG. 3, one remote responder R1 is available and gives a response to the request for assistance, while responders R2 and R3 are unavailable and do not. Responder R1 is shown having received the request by telephone call, responded by pressing the single digit return call number; for example, a pre-recorded voice message such as “John, it's me, I need help. Please call me back at telephone number xxx-xxx-xxxx.” In various examples, there may be a system message, such as, “Fall-Responsive Emergency System Event. Please call back.” When responder R1 acknowledges that the call has been accepted by an authorized responder, for example, by entering a numeric code via the phone keys to notify the system that the call has been accepted by an authorized responder and/or more directly by placing a return phone call, via link 74, 54, 52, and 51, base station 50 activates at least the nearest, and optionally all, of the local communicators 60 on the premises via wireless and/or wired signals 80, 80′. The fallen person wearing bracelet 12 and responder R1 can then communicate directly by voice through the nearest local communicator 60, even if the fallen person is immobile, as represented at 82, 84. For premises where there might be communication-interfering noise in rooms other than where a fall occurred, it would be possible to choose and program a protocol for activating only the local communicator 60 nearest to the fallen person; for example, by sensing the fall signal strength or the distance of bracelet 12 from each of the local communicators 60 on the premises 40. In other examples, the two-way communication may be automatically opened upon call connection to a live person without requiring entry of a code by the remote responder. Other examples are possible.

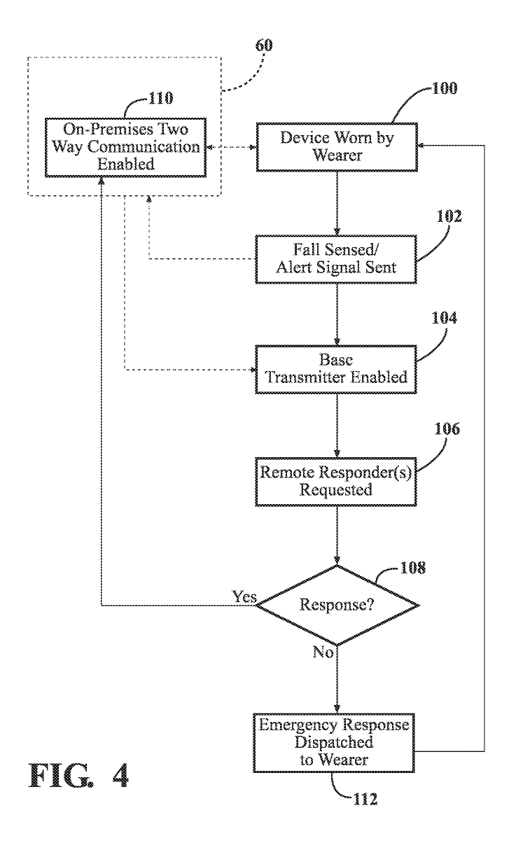

FIG. 4 schematically illustrates a method of sensing a fall and bringing a remote responder into communication with a fallen person wearing bracelet 12. At 100 a person at risk of a fall wears the fall-sensing device, for example bracelet 12. At 102 a fall is sensed (after the person has fallen or another triggering event has occurred), and a wireless alert signal is sent to the appropriate receiver, whether directly to a base station transmitter at 104 or indirectly via a local communicator or other intermediate device at 110. At 104 the base station transmitter is enabled to initiate communications to one or more remote responders which is sent off-premises at 106 to one or more remote responders. At 108 the one or more remote responders either respond or they do not. If a responder does respond, two-way voice communication is enabled on-premises at 110 directly with the fallen person still wearing the device at 100. Two-way communications are opened between the communications link through base station transmitter and one or more local communicators. If no responder responds, a less personal emergency responder unit, such as police, fire department, or ambulance service, is requested by the base station transmitter; for example, with a phone call to 911 and a pre-recorded message for help along with address information and the likely nature of the emergency (a fall). In the event that only a 911-type emergency unit is requested by the system, the local on-premises communicators 60 are also activated for two-way voice communication, but in this instance between the fallen person and the 911 operator and/or personnel en route.

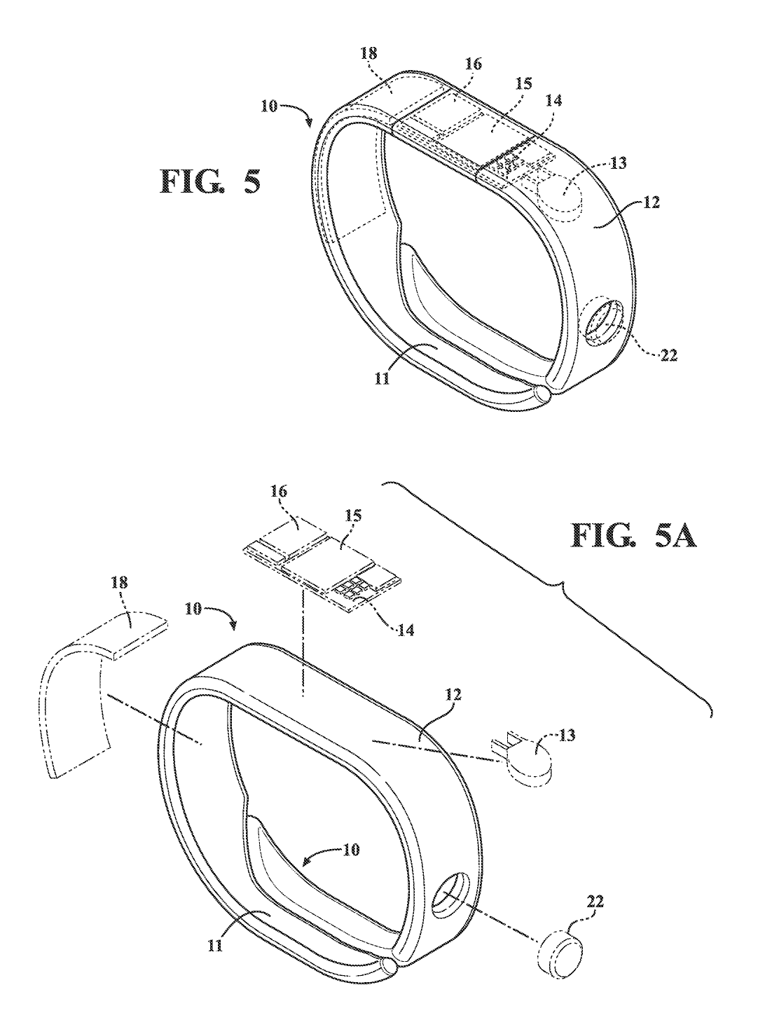

Referring now to FIG. 5, a wearable device 10 is shown in exemplary form. Wearable device 10 is illustrated as a bracelet 12 worn on the wrist, although it may take different forms provided the device is “wearable” or “worn”, i.e. can be carried or worn and retained on a person without conscious effort once donned or applied. Alternate examples of wearable device forms include, but are not limited to, necklaces, rings, pin-on items, belts, watches, belt attachments, bands around the chest, items capable of being carried in a pocket, and articles of clothing.

Bracelet 12 may be made from different materials, in the illustrated form being a combination of metal and polymer materials. Some examples of bracelet 12 may be substantially water resistant so as to prevent water from entering bracelet 12 so that a user may wear bracelet 12 in the bath, shower, swimming pool, or other wet locations. Bracelet 12 may be adjustable as illustrated at 11. Other examples may have a fixed size, and various bracelets 12 may be made of different sizes. Bracelet 12 may completely enclose a user's wrist, as shown in this example, or it may be a cuff style bracelet 12 with an open portion adapted to fit on one or more inner portions of a user's wrist, as shown with reference to FIG. 1. Other materials and combinations of materials, including precious metals and gems so that the bracelet functions as jewelry or the addition of texting screens for reminders and cueing, are also possible.

In the illustrated example, bracelet 12 includes a controller device 14, in the illustrated example a chipset housing incorporating one or more chips or integrated circuits; a fall sensor 16 embedded in or otherwise secured to the body of bracelet 12; a battery 18; and wiring 20 contained or embedded in the body of the bracelet to interconnect chipset 14, fall sensor 16, and battery 18 with respect to electrical power needs and signal communication. Chipset 14 may include a wireless transmitter function, or a separate wireless transmitter 15 may be incorporated in the bracelet and connected with wiring 20 to chipset 14, sensor 16, and battery 18 as needed. Chipset 14 may also include GPS and/or USB functionality and connections. While the functional components of bracelet 12 are illustrated as being embedded in or otherwise integrated into the bracelet, other methods for securing or attaching some or all of the components should be possible, including external attachments and making the body of bracelet 12 hollow to permit internal mounting of components.

Suitable devices for carrying out the functions of chipset 14, transmitter 15, and sensor 16 are commercially available and known. Chipset 14, for example, may be a CSR BlueCore 5 chipset or Qualcomm/Texas Instruments equivalent. Transmitter 15 may be a standard use 915 mHz, 2.4 GHz, or 6.0 Ghz transmitter of any type commonly used in wireless phone applications. Sensor 16 may be an acceleration sensor or a vibration sensor, such as a VTT or TI standard chip base accelerometer. These examples are currently contemplated, but it should be understood that alternatives exist. Also, chipset firmware 14 can be suitably programmed or encoded to coordinate the interaction of fall sensor 16 and transmitter 15. While a chipset is illustrated as the device for effecting and controlling the functionality of bracelet 12, alternatives and equivalents, including, but not limited to, other types of controller, software, hardware, and/or firmware, may be suitable.

Fall sensor 16 is responsive to a physical effect of a fall or push, whether measured by vibration, shock, acceleration, sound, a combination of the foregoing effects, or some other measurable physical effect of a fall as determined to be desirable. These may vary according to the intended use, the intended location, or the expected risk to an end-user wearing the bracelet. In the illustrated example it is assumed that fall sensor 16 is a vibration sensor of the chip-based accelerometer type. Also, more than one type of fall sensor 16 may be incorporated in bracelet 12 to sense more than one physical effect of a fall; for example, a vibration sensor and an acceleration sensor may be used in parallel to sense a wider range of physical effects that would indicate that a fall has taken place.

A fall event may be sensed by the fall sensor 16 in various manners and by various methods. For example, fall sensor 16 may measure the movement activity of a user and determine that a fall event has occurred by the relative measurements of activity, recognizing a fall upon sensing a relatively large impact user activity followed by a period of substantial inactivity, no activity, or substantially reduced activity. Other fall and/or activity measurements are possible by fall sensor 16 to determine the incident of a fall event. For example, a settling time after impact of the initial fall and the subsequent callout time may be measured and timed. One or more algorithms capable of governing the fall event may be manually calibrated for an individual's age, height, physical condition(s), and/or weight. The algorithm may also be calibrated to detect substantially abrupt and/or a very narrow range of abrupt motions that may indicate a stumble or misstep. The algorithm sequence may be expanded to monitor, collect, transmit, store and analyze timing and sequence of motion or minor motion events for predictive purposes. The algorithm may include capturing of horizontal and rotational motions associated with fall events. It may be capable of determining and/or predicting the body position of a user in some examples. Other examples are possible.

When someone wearing bracelet 12 falls, fall sensor 16 is activated to generate a sensed-fall signal that is transmitted by wiring 20 to chipset 14 and/or transmitter 15. Chipset 14 responds to the sensed fall signal to activate transmitter 15, which sends a wireless alert signal to an appropriate receiver at a distance from the person wearing bracelet 12. The person wearing the device need not consciously activate the bracelet to generate the wireless alert signal and need not be conscious for the alert signal to be sent-bracelet 12 responds to the sensed physical effect of the fall or emergency event without conscious input by the user.

Illustrated bracelet 12 also has a manual alert actuator 22, in the example shown as a recessed button on the inside (or alternately outside) surface of bracelet 12. This can be a button or switch of any type. In the illustrated example, actuator 22 is imbedded in the bracelet housing to maintain a smooth surface contour. It may be activated upon depression and/or after a pre-set time interval of depression (such as five seconds). In other examples, actuator 22 may be exposed on both the inside and outside of the bracelet so that it must be located and squeezed between the thumb and pointer finger of the user from both sides in order to prevent unintentional activation by bumping or normal activity. Button 22 can be intentionally activated by a person wearing the device to send an alert signal for non-fall or emergency events or sudden illnesses or as a backup to the automatic generation of an alert signal by the fall sensor 16. In some examples, button 22 may include an LED that may illuminate, such as to inform a user of wireless connectivity to a local communicator 60, one or more power modes, and/or one or more charging modes.

Button 22 may be depressed so as to cancel a manual alert inadvertently sent. For example, tapping button 22 after an alert has been sent may trigger a second communication from bracelet 12 to cancel the manual alert. Other bracelet 12 examples may include a waving functionality for cancelling a manually sent signal so as to cancel the manual alert upon detection of a hand waving motion by bracelet 12. Other types of manual alert actuators are possible, including, but not limited to, voice-activated actuators responsive to certain key words.

Bracelet 12 may also be provided with a vibratory output alert 13, in the illustrated example a three-vibe alert triggered by the activation of button 22 to send a vibratory warning to the user that a wireless alert notice is about to be sent from the bracelet to the base station. This gives the wearer an opportunity to cancel the alert signal, for example with another press of button 22, in case the activation was accidental. Vibratory output alert 13 may indicate other information, such as low battery power for bracelet 12, a change in a power mode, or other information.

Bracelet 12 may include a RF radio, Bluetooth radio and/or other communications protocol for communicating with local communicators 60 and/or base transmitter 50.

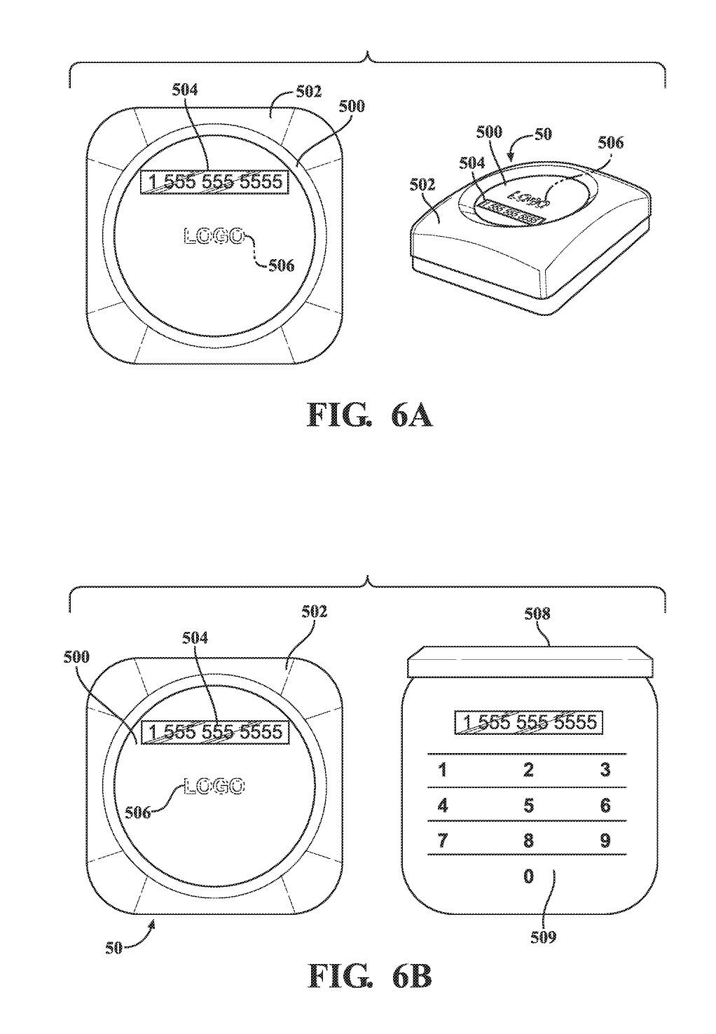

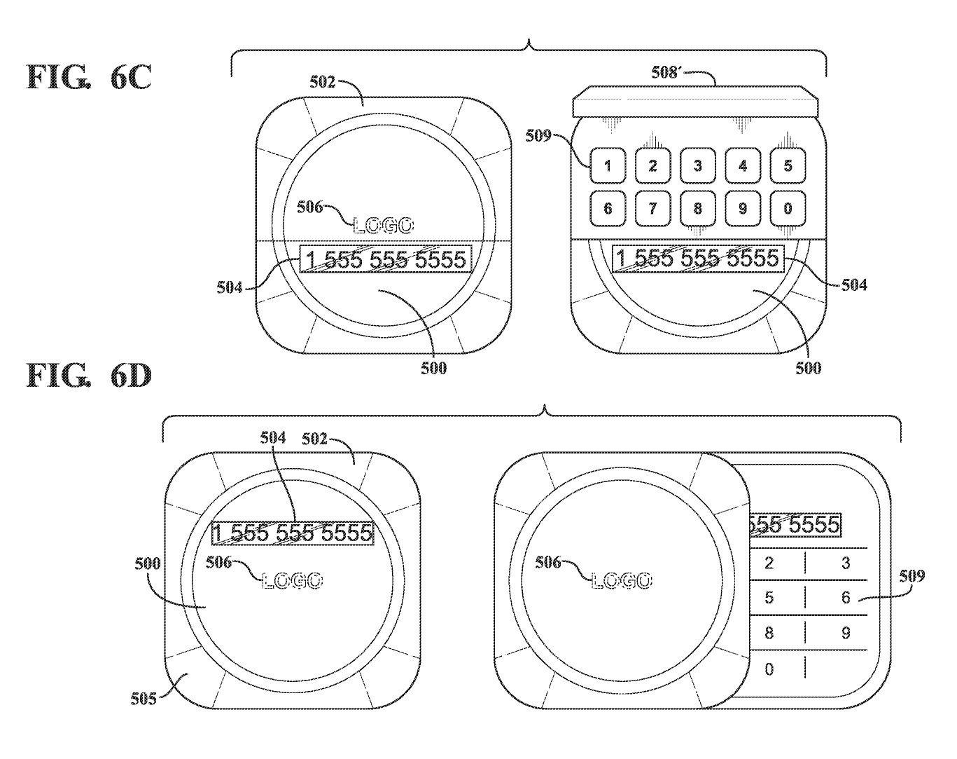

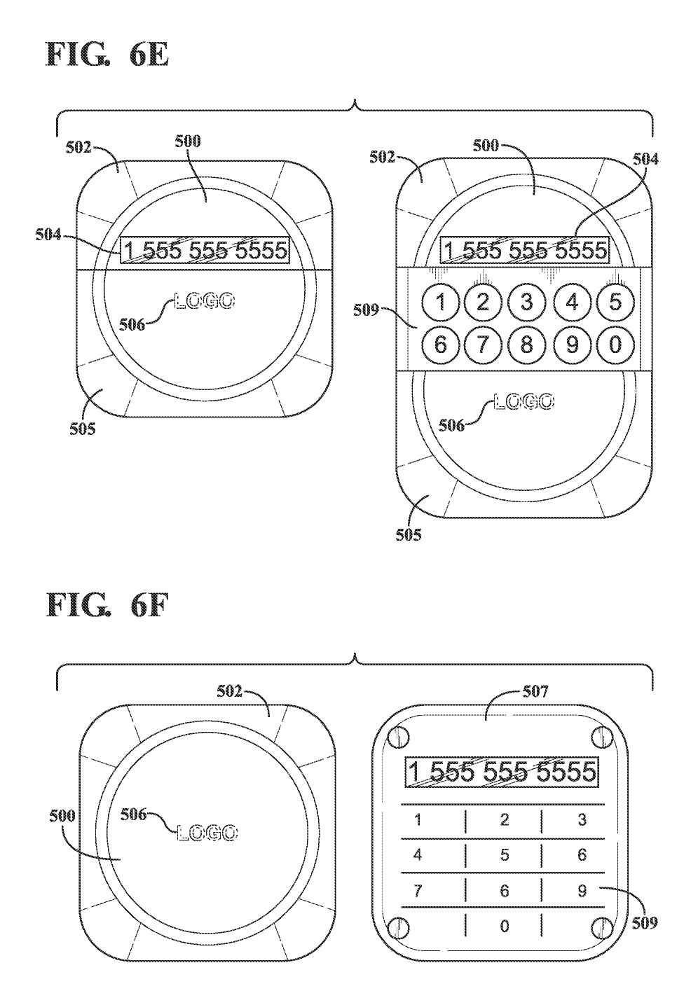

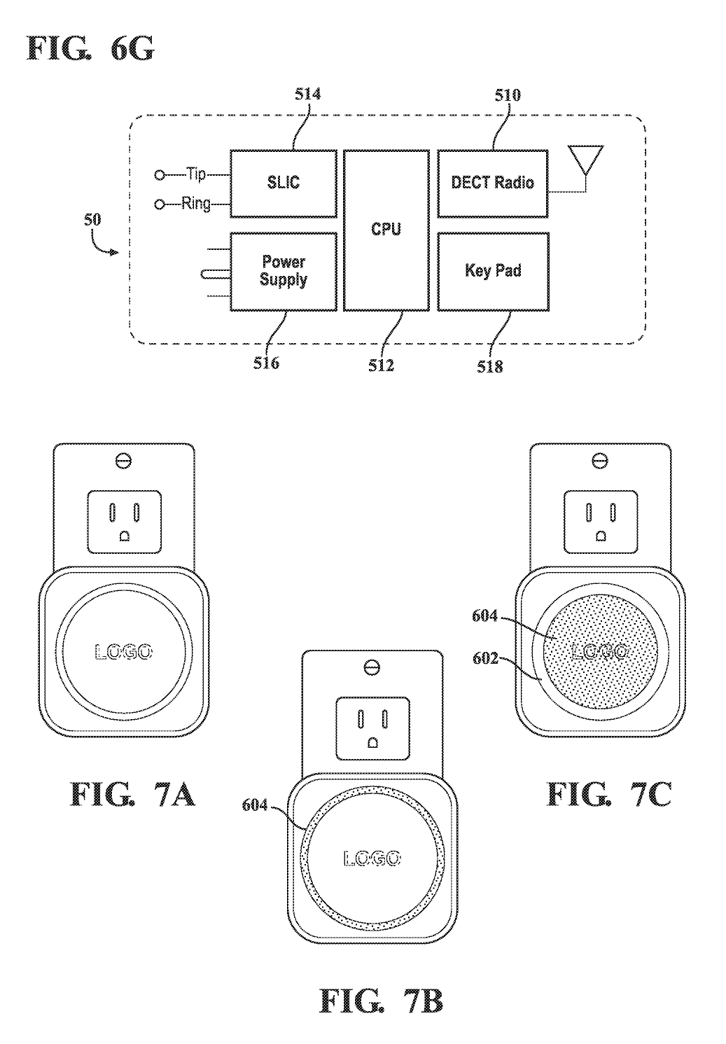

FIGS. 6A-6F show examples of base transmitter 50 which may also be referred to base transmitter 50 interchangeably throughout this application. Base transmitter 50 may include a keypad and/or a glow light in various examples. FIG. 6A shows a base transmitter 50 that has a glow unit 500 illuminated by light (not shown) that may illuminate one or more portions of upper surface 502 of base transmitter 50. The glow unit 500 may illuminate one or more alarms, alert message, such as, but not limited to, a contact number 504 being contacted or called by base transmitter 50 upon receipt of an alert signal from local communicator 60 alerting the system that a fall or emergency event has occurred. The glow unit 500 may illuminate other messages or alerts programmed for display on base transmitter 50. Base transmitter 50 may display a logo or other message 506 on its upper surface which may be illuminated by the glow unit 500, and/or viewable without the glow unit 500 being illuminated. Other examples may not include logo 506. Various lighting options known in the art, including, without limitation, one or more LED lights, may be used to illuminate glow unit 500. In various examples, glow unit 500 may become illuminated upon system activity, such as initiating a communication upon fall detection by the system. In other examples, there may be a button, switch, touch screen functionality or other mechanism known in the art that may be used to illuminate glow unit 500 manually. In other examples, the glow unit 500 and/or information to be viewed 504 and/or 506 may be placed on other surfaces on base transmitter 50. Claimed subject matter is not intended to be limited to this particular example.

Base transmitter 50 may be adapted for plugging directly into an electrical outlet. It may contain integral to base transmitter 50 an electrical plug for plugging into an outlet. It may have U.S. wall power plug in and/or other plug-in and/or port capabilities. For example, base transmitter 50 may include a plug adaptor kit so as to be capable of plugging into different wall power outlets. This may be used for portable applications of the system or otherwise. Base transmitter 50 may include a different plug type integrated into base transmitter 50 for use with different electrical systems. For example, base transmitter 50 may be adapted for plugging into a Europoean “Type C” socket and/or a British “Type G” socket. Base transmitter 50 may be adapted for plugging into an automobile lighter or other charging ports or outlets.

FIGS. 6B-6F shows example base transmitters 50 with a programmable keypad 509. In various examples, keypad may be backlit and/or have backlit numbers, such as, but not limited to, with LED lighting so as to illuminate the keypad.

FIG. 6B shows another example of base transmitter 50, including a glow unit 500 on its upper surface 502, which may illuminate a message, such as a telephone number 504, being called by base transmitter 50, and/or a logo 506 or other message. In this example, base transmitter 50 has a flip cover 508 which may be flipped to open to reveal keypad 509. Key pad 509 may be used to program into the system one or more telephone or other contact numbers for the system to contact, such as for if a fall incident is sensed by the system.

FIG. 6C shows another possible example with a different display configuration on upper surface 502 of illuminated telephone phone number 504 and logo 506 upon glow surface 500. This example shows a partial flip cover 508′ such that glow unit 500 is located on the lower portion of upper surface 502 of base transmitter 50. In this example, logo 504 is not a part of glow unit 500. When partial flip cover 508′ is in an open position, glow unit 500 and telephone number 504 are visible, as well as keypad 509. In this example, glow unit 500 may become illuminated as described above with reference to FIG. 6A and also upon entry of data upon keypad 609.

FIG. 6D shows an example with a sliding cover 505 that may be moved aside to access keypad 509. Keypad 509 may include a display portion to display the contact numbers being programmed into base transmitter 50.

FIG. 6E shows an example base transmitter 50 having a cover 505 that may cover a portion of upper surface 502 of the base transmitter 50 and which may slide down to reveal key pad 509. In a closed position and in an open position, both cover 505 may be viewed along with glow unit 500, and cover 505 may be separate from glow unit 500.

FIG. 6F shows an example base transmitter 50 with a keypad 509 located on its bottom surface 507. Glow unit 500 of FIG. 6f is depicted in a non-illuminated state with logo 506 viewable without illumination. Keypad 509 may include a display portion for displaying a contact number being programmed into the system. Base transmitter 50 may also have a bottom display, such as, but not limited to, a scrolling LED display (not shown), capable of displaying information about a user, such as vital information about a user with the wearable device. Such vital information could include data, including, but not limited to, allergies, medication, age, doctor information, hospital information, DNR instructions, or other information that may be accessible to a responder, such as an emergency responder, in the event of a health or other system triggering event. User information and updates thereto may be programmed into base transmitter 50 during system installation, set-up or any time thereafter. In various examples, user information may be associated with a particular wearable device, which may be helpful for system embodiments, including more than one wearable device for more than one user.

Other examples of base transmitter 50 may include one or more additional ports, such as, but not limited to, USB, Ethernet, telephone, and/or proprietary plug-in receptacles, for plugging other devices into base transmitter 50. Other devices could include, by way of example, handheld electronic devices used by medical responders and many other devices. For example, a port may comprise an external interface such as a serial port, parallel port, universal serial bus (USB) port, charge coupled device (CCD) reader, scanner, compact disc (CD), compact disk read-only memory (CD-ROM), digital versatile disc (DVD), video capture device, T tuner card, 802×3 devices, and/or IEEE 1394 serial bus port, infrared port, network adapter, printer adapter, radio-frequency (RF) communications adapter, universal asynchronous receiver-transmitter (UART) port, and newer developments thereof, and/or the like, to interface between corresponding I/O devices and/or other devices.

FIG. 6G shows a block diagram of example components of base transmitter 50. Base transmitter 50 may include transceiver 510, such as, but not limited to, a DECT radio transceiver that is capable of receiving an activation signal from local communicators 60. Base transmitter 50 may include communications gateway 514, such as, but not limited to, a subscriber line interface (SLIC) capable of initiated dial-out or other outward communications in response to receipt of an activation signal from local communicators 60.

Base transmitter 50 may include a power supply 516 that is capable of providing power to the device. In various examples, this may include a battery that is capable of being recharged with AC power and a port for an AC power adapter to plug into base transmitter 50. For example, power supply may be adapted to receive standard line voltage (120 VAC) and convert it to a stable 5V power supply for base transmitter 50. Power supply 516 may include power switching functionality for switching between battery power, adapter power, or other power sources.

Base transmitter 50 may include keypad 518, as shown in FIGS. 6B-6F. Base transmitter 50 may include CPU 512 that is adapted to process functionality, such as call initiation by communication gateway 514 upon receipt of a triggering signal by transceiver 510. Communications gateway 514 may include telephone, Ethernet, wireless, and/or other communications links and capabilities as discussed above.

Base transmitter 50 may also include memory (not shown) for storing pre-programmed contact numbers entered upon keypad 518. In other examples, CPU 512 may include memory, such as but not limited to, flash memory capable of storing pre-programmed contact information and operating software or firmware instructions for carrying out base transmitter communications functionality and RAM memory capable of supporting operation of base transmitter 50. CPU 512 is capable of processing outward calls by communications gateway 514 in accordance with contact information input on keypad 518. CPU may also process functionality for opening up two-way communications between a remote responder and the user of bracelet 12 via communications gateway 514 and to local communicator 60 via transceiver 510. CPU 512 may have adequate I/O to support radio and other communications, audio controls, and peripheral tasks, such as, without limitation, switch interface, LE, power supply control and power management.

Base transmitter 50 may include one or more ports into which another device may be plugged. For example, base transmitter 50 may include a USB, micro USB, proprietary port, electrical outlet or other port. Base transmitter 50 may be capable of providing power to a device plugged into it, such as if base transmitter 50 is plugged into an electrical outlet. Other versions of base transmitter 50 may include a battery for battery power and/or back-up battery power which may also provide power to other devices plugged into base transmitter 50 in some examples. Base transmitter 50 may be adapted for receiving and/or transmitting data to a device plugged into a port thereon. Other examples are possible.

Of course, various other base transmitter 50 configurations are possible, including other types of covers, displays, components, and layouts. Claimed subject matter is not intended to be limited to a particular example or display.

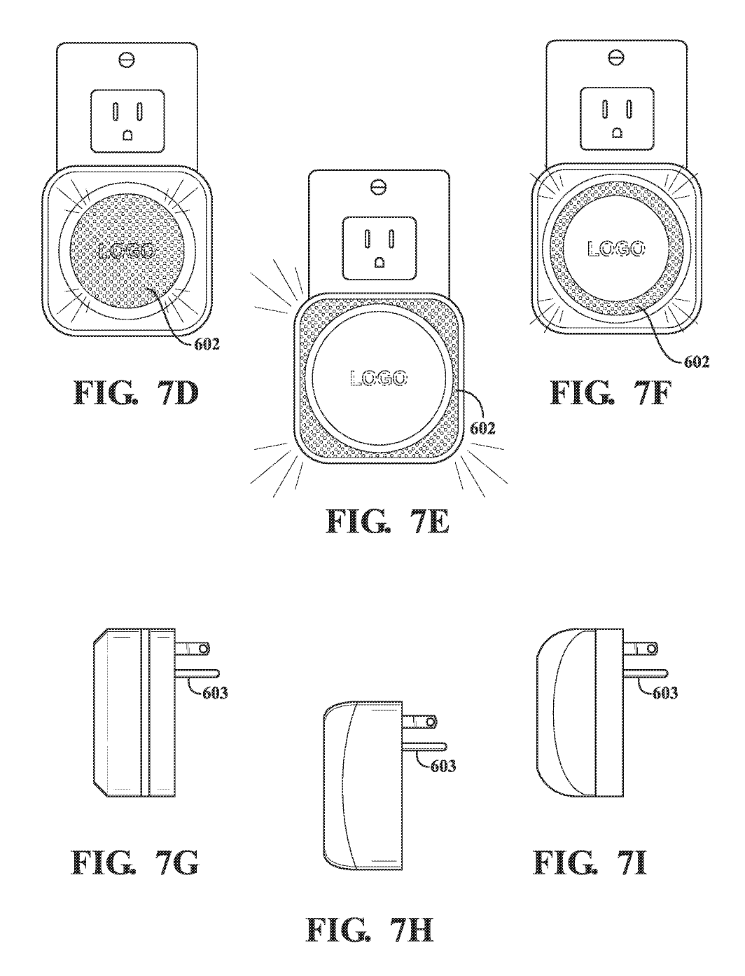

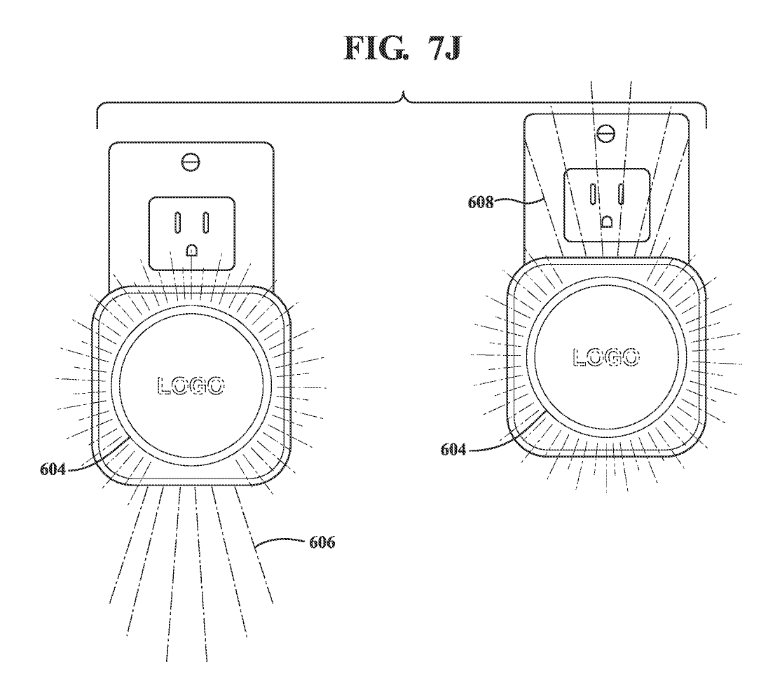

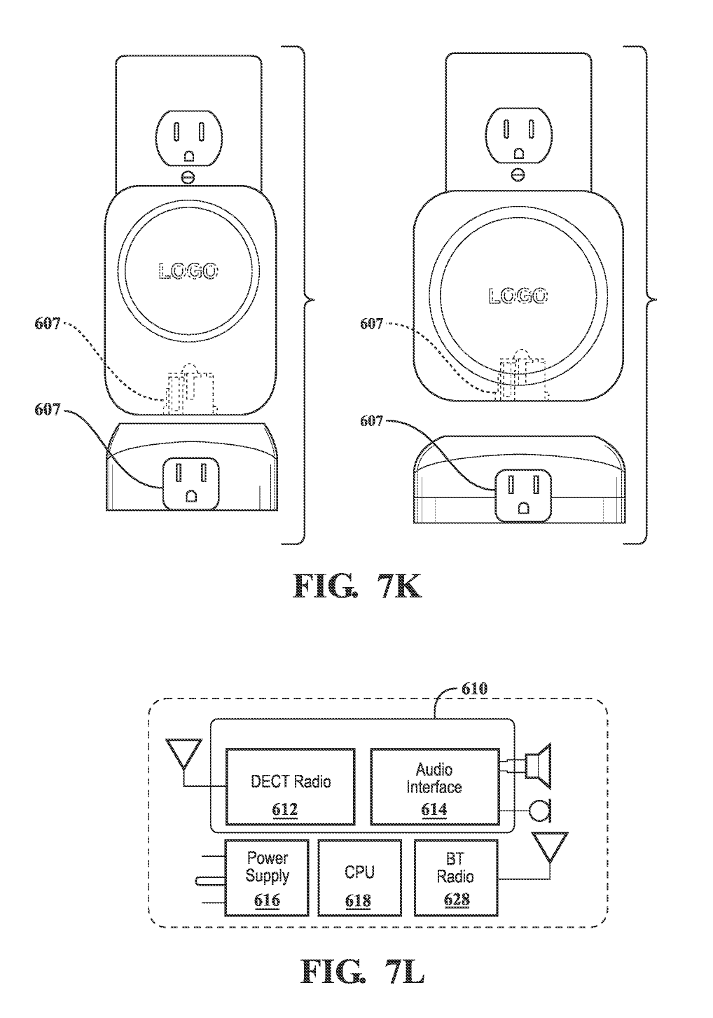

FIGS. 7 and 7A-7K depict examples of local communicators 60, which are shown in these examples as wall units. In some system 500 examples, there may be a plurality of local communicators 60. In some examples, there may a local communicator 60 in every room of a premises. A system 500 having one local communicator 60 is also possible.

In the illustrated examples, local communicator 60 is a plug-in, two-way voice type similar to an intercom unit. Communicator 60 is illustrated with a main housing, for example, molded from a durable polymer material, with a front face having speaker slots 602 and hidden receiver and transceiver speakers (not shown) and AC outlet prongs 603 capable of being plugged into a standard AC electrical outlet in a wall or other convenient location. An optional decorative or protective cover can be used over communicator 60. Options such as night-lights, ambient lighting, battery backup power, status indicator lights, flashing alert lights for hearing-impaired caregiver responders who are located on-premises, intercom functionality, surround sound, and others can be incorporated into or combined with communicator 60.

In the illustrated example, communicator 60 uses a 2.8 Ghz surround sound speaker-and-microphone system of known and commercially available type to provide clear two-way voice communication and, if necessary, clear listening by an on-premises caregiver responder. Communicators 60 can also provide the ability to communicate with emergency personnel on-site when enabled.

In a further form, local communicator 60 is designed to be more permanently attached to a wall outlet in replacement of the normal outlet cover plate, for example with screws fitting the outlet mounting box, so that communicator can be considered a “fixture” for insurance purposes and so that children, cleaning people, etc., are not likely to temporarily remove it from the wall and then forget to put it back. Securing the communicators 60 as “fixtures” may also provide additional value to the home as a system when the home is sold.

Local communicator 60 may contain other plug-in and/or port capabilities. For example, local communicator 60 may include a plug adaptor kit so as to be capable of plugging into different wall power outlets. Local communicator 60 may include a different plug type integrated into local communicator 60 for use with different electrical systems. For example, local communicator 60 may be adapted for plugging into a Europoean “Type C” socket and/or a British “Type G” socket. Local communicator 60 may be adapted for plugging into an automobile lighter or other charging ports or outlets.

Local communicator 60 may include one or more ports into which another device may be plugged. For example, local communicator 60 may include a USB, micro USB, proprietary port, electrical outlet or other port. Local communicator 60 may be capable of providing power to a device plugged into it, such as if local communicator 60 is plugged into an electrical outlet. Other versions of local communicator 60 may include a battery for battery power and/or back-up battery power which may also provide power to other devices plugged into local communicator 60 in some examples. Local communicator 60 may be adapted for receiving and/or transmitting data to a device plugged into a port thereon. Other examples are possible.

Local communicator 60 may contain speaker slots 602 and/or a glow unit 604. FIGS. 7A-7L show various configurations and different types of speakers 602. In FIG. 7A, the speaker slots 602 are not visible from the upper surface of local communicator 60. In FIG. 7C, speaker slots 602 are visible in a ring. In FIG. 7D, speaker slots 602 are visible as a circle. In FIG. 7E, speaker slots 602 are visible on the upper surface of local communicator 60 apart from in the center portion of the upper surface. In FIG. 7, speaker slots 02 are viewable as a ring. Many other possible speaker and speaker slot configurations are possible with local communicator 60, and these examples are not meant to be limiting.

As shown in FIGS. 7B, 7C and 7J, local communicator 60 may also contain a glow unit 604. Glow unit 604 may be capable of illuminating one or more portions of the upper surface, top surface or other surfaces of local communicator 60. Glow unit 604 may be capable of including more than one lighting settings. For example, as shown in FIG. 7J, glow unit 604 may have lower illumination lighting 606 illuminating downwards from local communicator 60 and/or upper illumination lighting 608 illuminating upwards of local communicator 60.

Glow unit 604 may have regular and/or lower level of illumination lighting 606 to indicate that it is operational. This may be a night light setting. In other examples, regular illumination level 606 may be a night light illumination that is turned on in response to a low lighting condition sensed by a light sensor (not shown) in local communicator 60. Glow unit 604 may have a second illumination level setting 608 having a higher level of illumination to indicate system events, such as an alarm, alert, fall detection, notification signal, call placement by the local communicator 60, or other messages or system happenings. In other examples, second illumination level setting 608 may be a beacon location light such that the local communicator 60 closest to the bracelet 12 when receiving a fall or emergency event signal would illuminate at level 608 and/or pulse light upwards of local communicator 60. This beacon light feature may orient a user who is wearing bracelet 12 to the nearest local communicator 60 and/or to clue first responders arriving on the scene where in the premises the fall or emergency event took place and the user is located. These are merely possible examples of local communicator 60 possible within the scope and spirit of this application, and claimed subject matter is not intended to be limited to these particular examples.

Local communicator 60 may have various profiles, as shown in FIGS. 7G, 7H and 7I with various designs. Claimed subject is not intended to be limited to a particular profile. As shown in FIG. 7K, local communicator 60 may include an electrical outlet 607, such as on a side surface, which may be accessible to plug other devices into local communicator 60 so as to provide another electrical outlet. Other examples may include other ports, such as USB ports or mini-USB ports. USB ports may be used, for example, for charging smartphone, tablets or other devices. Claimed subject matter is not intended to be limited to this optional feature of some examples of local communicator 60. Fig. J shows that local communicator 60 may have a light illuminating downwards from it and/or upwards from it, in addition to illumination of one or more parts of its top surface. Various illumination configurations are possible, and claimed subject matter is not intended to be limited to these particular examples.

In some examples, the system may include stereo and/or surround sound capabilities for local communicator 60. For example, local communicator 60 may via blue tooth or other wireless or remote communications protocol known in the art communicate and/or remotely connect to further electrical devices such as stereo receivers and/or speakers so as to provide additional speaker capabilities of the system.

In some examples, local communicator 60 may have “hands-free” capabilities that allow for hands-free answering of incoming communications, such as calls from responders who had received a fall or emergency event message via base transmitter 50 from the system. In this sense, local communicator 60 may act akin to a speakerphone and allow calling and/or talking functionality within a premises in a hands free manner.

Local communicator 60 may contain functionality for sensing where bracelet 12 is within a premises. For example, the system may include a base transmitter 50 and several local communicators 60. By communicating with base transmitter 50, as well as with other local communicators 60, local communicators 60 may create one or more wireless zones and/or a grid within the premises. User movement and activity throughout the grid may be tracked. Other examples may include GPS chips in bracelet 12 and/or other functionality for determining the location of bracelet 12.

System functionality may also act as an active zoning capacity. The wireless grid established by the local communicators 60 in communication with the base transmitter 50 may be used to set one or more perimeters and/or boundaries, such that if a user of bracelet 12 crosses a boundary, an alarm is triggered that may activate the call system functionality of base transmitter 15. Various perimeters could trigger alarms if a user of bracelet 12 wanders outside, into a basement, into an attic, up/down a staircase, into a car or other moving vehicle, etc. The possibilities are many, and these are but a few examples. In addition to the fall or emergency events discussed above, this could be another system triggering event. This system capability may be helpful for wander/elopement management, such as, but not limited to, for users having Alzheimer's or general confusion. Of course, this is merely one possible application for this system functionality, and claimed subject matter is not intended to be so limited.

FIG. 7L shows an example block diagram of local communicator 60. Local communicator 60 may include an ECT module 610 including a transceiver 612 and audio interface 614. Transceiver 612 may be a radio transceiver, such as a DECT radio, but other communications protocols are possible. Transceiver 612 is capable of sending and receiving communications signals from base transmitter 50. Audio interface 614 is adapted to provide signal conditioning of incoming radio or other communications audio signals from transceiver 612 and controlling quality of the audio signals, such as by eliminating feedback, howling or other noise interference. Audio interface 614 may include one or more speakers adapted to output voice communications from a remote responder to the premises of a user of bracelet 12. Speaker output may be set for hertz or decibel output in a range of human speech so as to reduce noise interference in other audio ranges. Audio interface 614 may include a microphone, such as an omnidirectional microphone, adapted to receive voice communications from a user of bracelet 12 in a premises. The microphone may be set for hertz or decibel output in a range of human speech so as to reduce noise interference in other audio ranges. Audio interface 614 may include echo cancellation and/or other sound processing and noise reduction functionality known in the art.

Local communicator 60 may include power supply 616 which may convert line voltage (120VAC) to digital supply voltages, such as 5V supply to rail circuits within local communicator 60. Power supply 616 may include a port for plugging local communicator into a wall outlet. Other power supply options, including battery and others, are possible. Power supply 616 may including switching functionality for changing a power supply.

Local communicator 60 may include CPU 618. CPU 618 is adapted to provide adequate speed and support for radio throughput and latency requirements of local communicator 60. CPU 618 may have adequate I/O to support radio and other communications signals, audio controls, and peripheral tasks such as, without limitation, switch interface, LE, power management, and power supply control. CPU 618 may include memory, such as flash memory and RAM. CPU 618 may include sufficient flash memory for running software or firmware and sufficient RAM memory to support operations.

Local communicator 60 may include communicator 620 for communicating with bracelet 12. Communicator 620 may be a Bluetooth radio communicator in various examples.

In some system examples, base transmitter 50 and wall unit 60 may be present in one device. In other examples, base transmitter 50 and wall unit 60 may be separate devices.

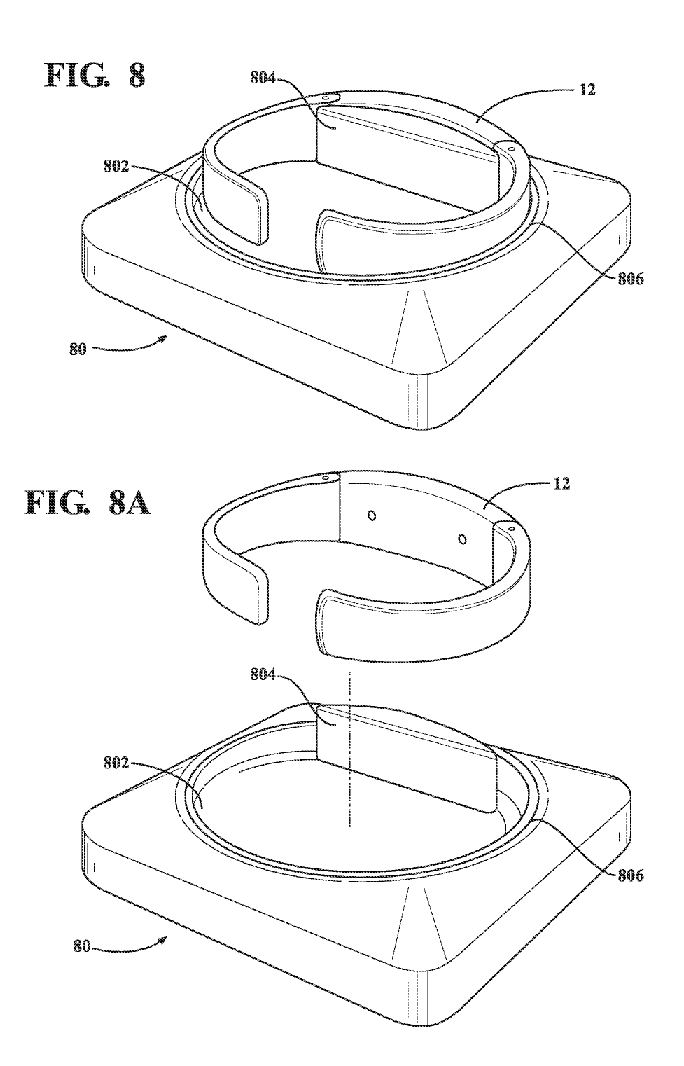

Referring now to FIGS. 8 and 8A, the system may include a charger unit for charging the wearable device or bracelet 12. The charger may be a charger plate 80, such as an induction charging plate. Charger plate 80 may be capable of accepting bracelet 12 upon a charging surface 802. In some examples, charging surface 802 may be elevated upon a unit. In some examples, the charging surface 802 may be substantially circular in shape and/or mimic one or more curvatures of bracelet 12.

Charger plate 80 may have a guide 804 containing one or more electrical contacts. Bracelet 12 may contain one or more electrical contacts (not shown) which are capable of making contact with the one or more electrical contacts within guide 804 so as to become electrically connected thereto to be capable of providing a charge to a battery in bracelet 12. In other examples, guide 804 may not contain electrical contacts but may instead be capable of aligning bracelet 12 on charging surface 802 so as to make electrical connection between electrical contacts within bracelet 12 and on charging surface 802. Guide 804 may be of various shapes, sizes and the like so as to position bracelet 12 upon charger plate 80 for charging. Some examples may have a guide 804 that is a groove or an elevated curb or curve, s as to position bracelet 12 for charging with the glow light active to confirm charging. Other configurations of guide 804 are possible. In some examples, charger plate 80 may not have guide 804, and the electrical contacts may be on or beneath charging surface 802.

Charging plate 80 may contain a glow unit 806 capable of illuminating one or more portions of charger plate 80. Glow unit 806 may be substantially ring shaped as shown in FIG. 8 or may be of other shapes and sizes. Glow unit 806 may illuminate, for example, if a bracelet is being charged. Glow unit 806 may cease illumination upon a full charge to bracelet 20. Other events triggering glow unit 806 are possible. An LED light may be used to indicate charging instead of or in addition to glow unit 806 in various examples.

Charging plate 80 may be powered by plugging it into a standard outlet or it may be powered via USB connection to a computing or other device or DC power, such as in an automobile. Various power options known in the art are possible. Charging plate 80 may include a wall transformer to convert power to that used by the device for operations. Charging plate 80 may include a charging monitor capable of managing an inductive or other power supply system. The charging monitor may set a charging rate, provide visual feedback regarding charging status, and/or manage wireless charging.

Other system examples may include wireless charging for bracelet 12. Wireless remote charging may allow for periodic and/or constant remote charging of bracelet 12 without requiring placement of bracelet 12 upon any charging station. Some bracelet 12 examples may include standard electrical outlet or vehicle plug-in adapter charging options.

System 500 of FIG. 1 may also include web portal 90. Web portal 90 may provide information to remote responders regarding activity of a user of bracelet 12 and/or act in a passive location monitoring and/or zoning capacity. In this manner, the system 500 may include a database server capable of receiving user information, wearable device location information or other information from base transmitter 50 and/or directly from the wearable device 10 in various examples. The database server may be remote using cloud based or other memory for storing data, and the data may be viewable via a web based portal 90 adapted for display upon a remote computing platform which may be separate from the premises and/or the database server. Web based portal 90 may be viewable on the premises as well. Caregivers or others may be able to remotely monitor the activity level of a user of bracelet 12, such as, but not limited to, to assess extended periods of inactivity via the web based portal.

Caregivers on premises may be able to enter data about the user via a mobile device or other computing platform, and the data may be synched with the user location and other system data via the remote database server and viewable upon web based portal 90. Web based portal 90 may contain one or more fields for a caregiver or other user to enter data, such as information about the user, medical conditions, etc. User activity and movements, as well as remote responder or caregiver data entries, may be synched via the remote database server.

Web portal 90 may display marketing, corporate history, product documents, contact information, ordering information, and other standard tools, including, without limitation, customer service, online chat, FAQ's and bug reporting, user guides and the like. Web portal 90 may have a login section that will allow the user/caregiver to secure access to complete one or more of the following tasks: register the system; create a unique ID and Password that pairs with the bracelet; create a personalized ‘information portal’ that may be personalized to the user and may include user information such as medical information (doctors, hospital, health history, medications); program information, such as contact information for remote responders; download system upgrades and/or updates; track movements of the bracelet within a premises for active and/or passive monitoring functions; provide a caregiver view that may allow a caregiver to enter information about a user and emergency provider information; and there may be geographic or GPS tracking outside of a premises.

System 500 may also include one or more mobile applications 94. Mobile application 94 may include functionality for editing system settings and user information, such as various biometric points (weight, height, g-force triggers, etc.), which may be entered via mobile application 94 and calibrated to personalize the fall system for the user.

A mobile application 94 may be used for system callout functionality. For example, callout functionality may also take the form of a text message in addition to a direct emergency call. Auto-email alerts to a responder list may also be triggered as a personal preference which may be controlled via a mobile application 94.

Mobile application 94 has capability to notify caregivers of fall/emergency events that occur outside of the premises, and integrate a GPS/location mapping capability that can notify responders of the user's location, such as in the event that the user is unable to communicate or is disoriented. Mobile application 94 may be capable of receiving location information regarding the location of bracelet 12, such as, but not limited to, the location of bracelet 12 when a fall alert is generated and/or sent.

Mobile application 94 may also be a caregiver application. A caregiver application may provide a log of the user's information that is entered by the user/caregiver, including any medication/physical information, etc., and provide a time-stamped history of the user's emergency events, daily movement, and other information to be determined.

Other mobile applications 94 are possible. Mobile applications 94 may be used on computing platforms, such as tablets, smartphones, scanners, handheld computing devices and other computing platforms.

A computing platform that may be used with the system, article, apparatus and methods described herein according to one or more examples is illustrated, although the scope of claimed subject matter is not limited in this respect. A computing platform may include more and/or fewer components than those discussed herein; however, generally conventional components may not be shown, for example, a battery, a bus, and so on.

A computing platform may be utilized to embody tangibly a computer program and/or graphical user interface, such as a web portal or mobile application, by providing hardware components on which the computer program and/or graphical user interface may be executed. A computing platform may be utilized to embody tangibly all or a portion of the website portal and/or mobile application features described above and/or other procedures disclosed herein. Such a procedure, computer program and/or machine readable instructions may be stored tangibly on a computer and/or machine readable storage medium such as a flash memory, cloud memory, compact disk (CD), digital versatile disk (DVD), flash memory device, hard disk drive (HDD), and so on.

A computing platform may be controlled by a processor, including one or more auxiliary processors. The functionality as described for the base unit 50, local communicators 60 and/or bracelet 12, and/or the processors discussed with reference to FIGS. 6G and 7L, may operate at least in part by use of a processor as described herein. A processor may comprise a central processing unit such as a microprocessor or microcontroller for executing programs, performing data manipulations, and controlling the tasks of the computing platform. Auxiliary processors may manage input/output, perform floating point mathematical operations, manage digital signals, perform fast execution of signal processing algorithms, operate as a back-end processor and/or a slave-type processor subordinate to a processor, operate as an additional microprocessor and/or controller for dual and/or multiple processor systems, and/or operate as a coprocessor and/or additional processor. Such auxiliary processors may be discrete processors and/or may be arranged in the same package as the main processor, for example, in a multicore and/or multithreaded processor; however, the scope of the scope of claimed subject matter is not limited in these respects.

Communication with a processor may be implemented via a bus for transferring information among the components of the computing platform. A bus may include a data channel for facilitating information transfer between storage and other peripheral components of the computing platform. A bus may further provide a set of signals utilized for communication with a processor, including, for example, a data bus, an address bus, and/or a control bus. A bus may comprise any bus architecture according to promulgated standards, for example, industry standard architecture (ISA), extended industry standard architecture (EISA), micro channel architecture (MCA), Video Electronics Standards Association local bus (VLB), peripheral component interconnect (PCI) local bus, PCI express (PCIe), hyper transport (HT), standards promulgated by the Institute of Electrical and Electronics Engineers (IEEE) including IEEE 488 general-purpose interface bus (GPIB), IEEE 696/S-100 and later developed standards, and so on, although the scope of the scope of claimed subject matter is not limited in this respect.

Other components of the computing platform may include, for example, memory, including one or more auxiliary memories. Memory may provide storage of instructions and data for one or more programs to be executed by the processor, such as a web portal and/or mobile application, functionality for the base transmitter, functionality for the wall unit, functionality for the bracelet, and/or other procedures disclosed herein, for example. Memory may comprise, for example, semiconductor-based memory, such as dynamic random access memory (DRAM) and/or static random access memory (SRAM), and/or the like. Other semi-conductor-based memory types may include, for example, synchronous dynamic random access memory (SDRAM), Rambus dynamic random access memory (RDRAM), ferroelectric random access memory (FRAM), and so on. Alternatively or additionally, memory may comprise, for example, magnetic-based memory, such as a magnetic disc memory, a magnetic tape memory, and/or the like; an optical-based memory, such as a compact disc read write memory, and/or the like; a magneto-optical-based memory, such as a memory formed of ferromagnetic material read by a laser, and/or the like; a phase-change-based memory such as phase change memory (PRAM), and/or the like; a holographic-based memory such as rewritable holographic storage utilizing the photorefractive effect in crystals, and/or the like; a molecular-based memory such as polymer-based memories, and/or the like; and/or a remote or cloud based memory and/or the like. Auxiliary memories may be utilized to store instructions and/or data that are to be loaded into the memory before execution. Auxiliary memories may include semiconductor based memory such as read-only memory (ROM), programmable read-only memory (PROM), erasable programmable read-only memory (EPROM), electrically erasable read-only memory (EEPROM), and/or flash memory, and/or any block oriented memory similar to EEPROM. Auxiliary memories also may include any type of non-semiconductor-based memories, including, but not limited to, magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), and so on. Remote and/or cloud memory is possible. Other varieties of memory devices are contemplated as well, and claimed subject matter is not intended to be limited to this one possible tangible medium.

A computing platform further may include a display. The display may comprise a video display adapter having components, including, for example, video memory, a buffer, and/or a graphics engine. A display may be used, for example, for viewing web-based portal data and/or a mobile application of the present system. Such video memory may comprise, for example, video random access memory (VRAM), synchronous graphics random access memory (SGRAM), windows random access memory (WRAM), and/or the like. The display may comprise a cathode ray-tube (CRT) type display, such as a monitor and/or television, and/or may comprise an alternative type of display technology, such as a projection type CRT type display, a liquid-crystal display (LCD) projector type display, an LCD type display, a light-emitting diode (LED) type display, a gas and/or plasma type display, an electroluminescent type display, a vacuum fluorescent type display, a cathodoluminescent and/or field emission type display, a plasma addressed liquid crystal (PALC) type display, a high gain emissive display (HGED) type display, and so forth. The display may be used to view any user interface information regarding the system, article, apparatus and methods, described herein, such as pre-programmed contact information of the base transmitter, website portal information, mobile application information and other information.

A computing platform further may include one or more I/O devices. An I/O device may comprise one or more I/O devices, such as a keyboard, touch screen, stylus, electroacoustic transducer, microphone, speaker, audio amplifier, bar code reader/scanner, and/or the like.

The computing platform further may include an external interface, which may comprise one or more controllers and/or adapters to prove interface functions between multiple I/O devices. For example, an external interface may comprise a serial port, parallel port, universal serial bus (USB) port, charge coupled device (CCD) reader, scanner, compact disc (CD), compact disk read-only memory (CD-ROM), digital versatile disc (DVD), video capture device, T tuner card, 802x3 devices, and/or IEEE 1394 serial bus port, infrared port, network adapter, printer adapter, radio-frequency (RF) communications adapter, universal asynchronous receiver-transmitter (UART) port, and newer developments thereof, and/or the like, to interface between corresponding I/O devices. Claimed subject matter is not intended to be limited to this particular example of a computing platform that may be used with the system, user interface and methods described herein.

It will, of course, be understood that, although particular examples have just been described, the claimed subject matter is not limited in scope to a particular example or implementation. For example, one example may be in hardware, such as implemented to operate on a device or combination of devices, for example, and another example may be in software. Likewise, an example may be implemented in firmware, or as any combination of hardware, software, and/or firmware, for example. Likewise, although claimed subject matter is not limited in scope in this respect, one example may comprise one or more articles, such as a storage medium or storage media. This storage media, such as one or more SD cards and/or networked disks, for example, may have stored thereon instructions that, if executed by a system, such as a computer system, computing platform, or other system, for example, may result in the system performing techniques for generating, transmitting or initiating signals in accordance with claimed subject matter.

The system may be used to signal personal emergency events in addition to and/or instead of fall events. It may be used for personal safety. For example, the system could also be used by mothers with infants in danger of being shaken by childcare providers or inexperienced babysitters. The set point or sensitivity of the fall sensor, for example an accelerometer, could be adjusted to detect a repeated, violent shaking and prompt an alert signal when worn on the ankle of an infant. Many other applications are possible.

The system may be used for locating individuals on a premises and/or off of a premises. For example, military applications may include soldier tracking during combat or other operations using bracelet 12 to communicate to command operations the locations of users and/or their movement activity within a vessel, battlefield, area and/or globally. In this sense, there is no requirement that base transmitter 50 or local communicators 60 be installed inside or within a single premises. Rather, a grid may be established to include multiple premises, campuses, areas, towns, cities, counties, globally, and the like.

The system may be used for fall events occurring as a result of internal health conditions of a user, or fall events from external, environmental and/or situational factors, events or forces. For example, internal health conditions that could contribute to and/or cause a fall event may include stroke, heart attack, low blood sugar, lack of oxygen, dehydration, and others. Fall events may be due to external factors, such as actions or movement by the user, non-action of the user, and/or choices of a user (such as over-medication, under-medication, mis-use of medication, intoxication, side effects from contraindication causing dizziness or confusion). Other external factors are possible. These external events may cause personal emergency events instead of and/or in addition to fall events.

Environmental factors may happen inside a home, workplace, hotel room, dorm or other places. Various system examples may be portable and/or packable and capable of being set up and/or installed in multiple locations. Environmental factors may include, for example, poor lighting, slippery rugs, wet floors, doorway lips, ladder climbing, or stairs. Environmental factors in the outdoors may include wet steps, snowy walkways or driveways, open patios, porches without railings, etc. Environmental factors may be present in or outside of a premises or out and about while running errands, going to work, visiting, traveling, etc. The present system may be used for these applications. Environmental factors may cause fall events and/or personal emergencies. For example, bracelet 12 may send an automatic or manual alert if a user falls due to an external force being applied, such as if in a car accident, boating accident, a tree limb or other object fall on and/or knocks a user down, or other external forces. Bracelet 12 may be used to notify a remote responder of fall or other emergency alerts and user location information associated with activities, such as, by way of example, a skiing accident, mountain climbing fall, hiking injury, and many more. Bracelet 12 may be used to communicate user location information and emergency information from earthquakes or other natural disaster, house fires, or other emergency situations.

Situational factors may include physical disability of a user, sensory or memory limitations of a user, mobility issues of a user, physical challenges of a user, and the like. Situational factors may also include personal safety factors, such as muggings, attacks, bullying, robbery, assault and the like. Outside physical forces, such as, but not limited to, pushings, shovings and kickings, may be factors leading to a personal emergency event contemplated by the present system. Psychological conditions, such as fear may cause a fall event and/or be a symptom of a personal emergency event. Both the automatic and manual alert capabilities of the present system may be used in such situations. For example, a child may use bracelet 12 to communicate falls or stumbles due to being pushed (such as from bullying activity), to alert a remote responder as to the child's location, and/or to allow a child to manually send an alert communication in situations where the child senses an emergency.

The system may be used for reverse security, such that a person entering a premises, or crossing a perimeter and/or boundary area without a bracelet 12 may trigger an alert, such as for applications including intruder detection, security systems, or to inform a remote responder of an unauthorized visitor entering a school and/or on a school campus. Many other applications for the present system and method are possible.

In the preceding description, various aspects and examples and configurations of making and using the invention as defined by the claimed subject matter have been described, for purposes of explanation, to provide a thorough understanding of claimed subject matter, and to enable those skilled in the art to make and use claimed subject matter. However, these are merely example illustrations, and descriptions of inventive concepts and other illustrations may apply as well, and the scope of claimed subject matter is not limited in these respects. It should be apparent to one skilled in the art having the benefit of this disclosure that claimed subject matter may be practiced without being limited to the specific details of the disclosure. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of invention as reflected by the preceding disclosure. It should further be understood that to the extent the term “invention” is used in the written specification, it is not to be construed as a limiting term as to number or type of claimed or disclosed inventions or the scope of any such invention and does not exclude discoveries or designs; rather, it is a term which has long been conveniently and widely used to describe new and useful improvements in technology.

What is claimed is:

1. In a system for sending an alert in response to a fall or emergency event comprising a wearable device comprising a sensor responsive to a physical effect of a fall by a user wearing the device to generate a sensed-fall signal, the wearable device further comprising a wireless transceiver capable of transmitting the sensed-fall signal, the system further comprising a plurality of local communicators capable of receiving the sensed-fall signal from the wearable device and generating a fall alert in response to receipt of the sensed-fall signal and transmitting the fall alert, the system further comprising a base transmitter capable of receiving the fall alert from the local communicators, the base transmitter comprising a communications portal capable of initiating one or more communications to one or more remote responders in response to receipt of the fall alert, the base transmitter is capable of opening up a two-way voice communication between the remote responder and the local communicator closest to the wearable device to allow for voice communication between the remote responder and the user of the wearable device, the improvement comprising:
the plurality of local communicators each comprising a transceiver capable of sending a wireless ping signal to the wearable device and receiving a response signal from the wearable device generated in response to receipt of the ping signal, the system configured to be capable of determining a location of the wearable device by determining which of the local communicators is nearest the wearable device base at least in part upon the ping and response signals.

2. The system of claim 1, the base transmitter comprising a programmable keypad capable of receiving and storing contact information for one or more remote responders and capable of initiating one or more communications to one or more remote responders using the stored contact information.

3. The system of claim 1, further comprising a mobile application adapted for use on a mobile computing platform of a remote responder; the mobile application capable of being activated upon receipt of a communication from the communication portal of the base transmitter to inform the remote responder of a fall or emergency event.

4. The system of claim 1 further comprising a web portal capable of being viewed on a computing platform and adapted to display location information for the wearable device.

5. The system of claim 4, the web portal capable of displaying location history information for the wearable device.

6. The system of claim 1 further comprising a charging plate adapted to charge the wearable device by induction charging.

7. The system of claim 1 further comprising a wireless charger capable of wirelessly charging the wearable device.

8. The system of claim 1, the plurality of local communicators capable of establishing one or more perimeters; the local communicators capable of sending a boundary alert signal to the base transmitter if the response signal is not received from the wearable device, the boundary alert signal capable of indicating that the wearable device is not within the perimeters.

9. The system of claim 1, the local communicators capable of generating an alert if the bracelet remains in the same location for a pre-determined period of time.

10. The system of claim 1, the local communicators further comprising a glow unit capable of illuminating.

11. The system of claim 10, the glow unit closest to the wearable device capable of illuminating in response to generation of an alert signal.

12. The system of claim 1, the system capable of tracking movement of the wearable device with regard to the local communicators based upon the ping and response signals from the local communicators and wearable device, the system configured so that the local communicator nearest the wearable device receives the sensed-fall or emergency event signal from the wearable device.

13. The system of claim 1, the wearable device comprising a bracelet.

14. The system of claim 1, the local communicator further comprising a port adapted for plugging a device into the local communicator.

15. The system of claim 1, the local communicators and base transmitter communicate by Bluetooth signals.

16. The system of claim 1, the local communicators and wearable device communicate by Bluetooth or RF radio signals.

17. The system of claim 1, the communications portal of the base transmitter further comprising a wireless gateway.

18. The system of claim 4, the communications portal of the base transmitter capable of communication to a remote database server that is adapted for receiving the wearable device location information from the communications portal, the remote database server capable of remote communication to the computing platform, the location information adapted for being displayed on the web portal.

19. For use in a system comprising a wearable device comprising a sensor responsive to a physical effect of a fall by a user wearing the device to generate a sensed-fall signal, the wearable device further comprising a wireless transceiver capable of transmitting the sensed-fall signal, the system further comprising a plurality of local communicators capable of receiving the sensed-fall signal from the wearable device and generating a fall alert in response to receipt of the sensed-fall signal and transmitting the fall alert, the system further comprising a base transmitter capable of receiving the fall alert from the local communicators, the base transmitter comprising a communications portal capable of initiating one or more communications to one or more remote responders in response to receipt of the fall alert, the base transmitter is capable of opening up a two-way voice communication between the remote responder and the local communicator closest to the wearable device to allow for voice communication between the remote responder and the user of the wearable device, a method comprising:
locating the wearable device within the premises by sending one or more ping signals from the local communicators to the wearable device, the wearable device generating a response signal in response to receipt of the ping signal and transmitting the response signal to the local communicators, the local communicator closest to the wearable device being identified in proximity to the wearable device by receipt of the response signal.

20. The method of claim 19, further comprising:
sending a communication to a mobile application adapted for use on a mobile device of the remote responder; the mobile application capable of being activated upon receipt of a communication from the communication portal of the base transmitter to inform the remote responder of the fall or emergency event and the location of the wearable device

21. The method of claim 19 further comprising:
providing a web portal capable of being viewed on a computing platform, the web portal adapted to display the location information for the wearable device.

22. In a system for sending an alert in response to a fall or emergency event comprising a wearable device comprising a sensor responsive to a physical effect of a fall by a user wearing the device to generate a sensed-fall signal, the wearable device further comprising a wireless transceiver capable of transmitting the sensed-fall signal, the system further comprising a local communicator capable of receiving the sensed-fall signal from the wearable device and generating a fall alert in response to receipt of the sensed-fall signal and transmitting the fall alert, the system further comprising a base transmitter capable of receiving the fall alert from the local communicators, the base transmitter comprising a communications portal capable of initiating one or more communications to one or more remote responders in response to receipt of the fall alert, the base transmitter is capable of opening up a two-way voice communication between the remote responder and the local communicator closest to the wearable device to allow for voice communication between the remote responder and the user of the wearable device, the improvement comprising:
the local communicator comprising a glow unit capable of illuminating upon generation of the fall alert;
the base transmitter comprising a programmable keypad capable of receiving and storing contact information for one or more remote responders; and
a charger capable of induction charging the wearable device.

23. The system of claim 22, further comprising:
a mobile application adapted for use on a mobile computing platform of a remote responder; the mobile application capable of being activated upon receipt of a communication from the communication portal of the base transmitter, to inform the remote responder of the fall or emergency event.
